(19) United States
(12) Patent Application Publication
(10) Pub. No.: US 2026/0370625 A1
(43) Pub. Date: Nov. 19, 2026

(54) NETWORK ARCHITECTURE AND NETWORK TRANSMISSION METHOD USING INTER-INTEGRATED CIRCUIT (I²C) SPECIFICATION

(71) Applicant: PRIMAX ELECTRONICS LTD., Taipei City (TW)

(72) Inventors: TZU-HSIANG LIN, Taipei City (TW); CHIH-WEI HU, Taipei City (TW); HUNG-CHANG CHEN, Taipei City (TW); WEI-TING CHEN, Taipei City (TW)

(21) Appl. No.: 19/250,108

(22) Filed: Jun. 26, 2025

(30) Foreign Application Priority Data
May 15, 2025 (TW) 114118343

(51) Int. Cl. H04L 61/5014; G06F 13/42; H04L 101/604

(52) U.S. Cl. CPC H04L 61/5014; G06F 13/4282; H04L 2101/604

(57) ABSTRACT

A network architecture includes a host unit and a plurality of module units. The host unit generates at least one request command packet. The plurality of module units are electrically connected with the host unit according to inter-integrated circuit specifications and in a series connection relationship. According to a network communication protocol including the at least one request command packet and the at least one response command packet, the host unit assigns a virtual dynamic address uniquely corresponding to each of the host unit and the plurality of module units and acquires a total number of the plurality of module units. Consequently, at least one application operation is performed. A network transmission method using inter-integrated circuit specifications is also provided.

### FIELD OF THE INVENTION

The present invention relates to a network architecture and a network transmission method, and more particularly to a network architecture and a network transmission method using inter-integrated circuit specifications.

### BACKGROUND OF THE INVENTION

The inter-integrated circuit (I²C) bus is usually used in small or low-speed network architectures (e.g., motherboards, mobile phones, or embedded systems) because its communication protocol content and configuration method are simpler than the network protocol used in general local area networks (such as TCP/IP) and its implementation cost is also lower. The inter-integrated circuit (I²C) bus is usually used in small or low-speed network architectures.

FIG. 1 schematically illustrates the topology of a conventional inter-integrated circuit (I²C) bus. The bus defined by the inter-integrated circuit (I²C) bus is applied in a network architecture. The network architecture includes a host unit (MS) and a plurality of slave units. As shown in FIG. 1, the plurality of slave units include a first slave unit S1, a second slave unit S2 and a third slave unit S3. The inter-integrated circuit (I²C) bus at least includes a serial clock (SCL) signal line and a serial data (SDA) signal line. In addition, the inter-integrated circuit (I²C) bus is connected with a plurality of pull-up resistors R.

The host unit MS and the slave units S1~S3 are connected with each other through the inter-integrated circuit (I²C) bus. Consequently, the host unit MS and the slave units S1~S3 are electrically connected in parallel to form a host-slave network architecture.

As mentioned above, all of the slave units S1~S3 on the network are interconnected through the same I²C bus (i.e., the serial clock (SCL) signal line and the serial data (SDA) signal line of the same set). Consequently, the data communication between the slave units S1~S3 can be successfully performed as long as there is no address conflict among the devices. However, if any of the slave units S1~S3 share the same device address or there is an address conflict, the entire network cannot operate properly.

In order to overcome the drawbacks of the conventional technologies, it is important to provide a network architecture with an inter-integrated circuit (I²C) bus in a cost-effective manner while effectively preventing the common issue of duplicate or conflicting device addresses in the conventional I²C systems.

### SUMMARY OF THE INVENTION

An object of the present invention provides a network architecture using inter-integrated circuit specifications. The network architecture includes a host unit and a plurality of module units in a series connection relationship.

Another object of the present invention provides a network transmission method using inter-integrated circuit specifications. By the network transmission method, a host unit assigns a virtual dynamic address uniquely corresponding to each of the host unit and the plurality of module units.

In accordance with an aspect of the present invention, a network architecture using inter-integrated circuit specifications is provided. The network architecture includes a host unit and a plurality of module units. The host unit generates at least one request command packet. The plurality of module units at least include a first module unit and a second module unit, which are electrically connected with the host unit according to the inter-integrated circuit specifications, wherein the plurality of module units generate at least one response command packet in response to the at least one request command packet. The first module unit is electrically connected with the host unit. The second module unit is electrically connected with the first module unit. Consequently, the host unit, the first module unit and the second module unit are connected with each other in a series connection relationship. According to a network communication protocol including the at least one request command packet and the at least one response command packet, the host unit assigns a virtual dynamic address uniquely corresponding to each of the host unit and the plurality of module units and acquires a total number of the plurality of module units. Consequently, at least one application operation is performed.

In an embodiment, each of the at least one request command packet contains a header and a payload.

In an embodiment, the header at least contains a target module address and a control command, and the payload contains a first packet data and a second packet data. A data length of each of the target module address, the control command, the first packet data and the second packet data is one byte.

In an embodiment, each of the at least one response command packet contains a header and a payload.

In an embodiment, the header contains at least a target module address, a control command and a payload length, and the payload contains at least one packet data. A data length of each of the target module address, the control command, the payload length and the at least one packet data is one byte.

In an embodiment, the at least one request command packet includes a request command packet for virtual dynamic address configuration, a request command packet for total module unit number acquisition and a request command packet for the at least one application operation.

In an embodiment, according to the request command packet for virtual dynamic address configuration, the virtual dynamic address uniquely corresponding to each of the host unit and the plurality of module units is assigned.

In an embodiment, according to the request command packet for total module unit number acquisition, the total number of the plurality of module units is acquired.

In an embodiment, according to the request command packet for the at least one application operation, at least one specification parameter of each of the plurality of module units is acquired or set, or an operation status of each of the plurality of module units during operation is acquired or set.

In an embodiment, after the at least one request command packet is sent from the host unit, the at least one request command packet is transmitted downstream through the plurality of module units layer by layer in a serial communication manner, and the at least one request command packet is transmitted to a specified module unit of the plurality of module units corresponding to a preset virtual dynamic address in the at least one request command packet. In response to the at least one request command packet, the specified module unit sends the at least one response command packet, and the at least one response command packet is transmitted upstream to the host unit through the plurality of module units layer by layer in the serial communication manner.

In accordance with another aspect of the present invention, a network architecture using inter-integrated circuit specifications is provided. The network architecture includes a host unit and a plurality of module units. The host unit generates at least one request command packet. The plurality of module units at least include a first module unit and a second module unit, which are electrically connected with the host unit according to the inter-integrated circuit specifications, wherein the plurality of module units generate at least one response command packet in response to the at least one request command packet. The first module unit is electrically connected with the host unit. The second module unit is electrically connected with the first module unit. Consequently, the host unit, the first module unit and the second module unit are connected with each other in a series connection relationship. After the at least one request command packet is sent from the host unit, the at least one request command packet is transmitted downstream through the plurality of module units layer by layer in a serial communication manner, and the at least one request command packet is transmitted to a specified module unit of the plurality of module units corresponding to a preset virtual dynamic address in the at least one request command packet. In response to the at least one request command packet, the specified module unit sends the at least one response command packet, and the at least one response command packet is transmitted upstream to the host unit through the plurality of module units layer by layer in the serial communication manner.

In an embodiment, each of the at least one request command packet contains a header and a payload.

In an embodiment, the header at least contains a target module address and a control command, and the payload contains a first packet data and a second packet data. A data length of each of the target module address, the control command, the first packet data and the second packet data is one byte.

In an embodiment, each of the at least one response command packet contains a header and a payload.

In an embodiment, the header contains at least a target module address, a control command and a payload length, and the payload contains at least one packet data. A data length of each of the target module address, the control command, the payload length and the at least one packet data is one byte.

In an embodiment, according to a network communication protocol including the at least one request command packet and the at least one response command packet, the host unit assigns a virtual dynamic address uniquely corresponding to each of the host unit and the plurality of module units and acquires a total number of the plurality of module units, so that at least one application operation is performed.

In an embodiment, the at least one request command packet includes a request command packet for virtual dynamic address configuration, a request command packet for total module unit number acquisition and a request command packet for the at least one application operation.

In an embodiment, according to the request command packet for virtual dynamic address configuration, the virtual dynamic address uniquely corresponding to each of the host unit and the plurality of module units is assigned. According to the request command packet for total module unit number acquisition, the total number of the plurality of module units is acquired. According to the request command packet for the at least one application operation, at least one specification parameter of each of the plurality of module units is acquired or set, or an operation status of each of the plurality of module units during operation is acquired or set.

In accordance with another aspect of the present invention, a network transmission method for a network architecture using inter-integrated circuit specifications is provided. The network architecture includes a host unit and a plurality of module units. The plurality of module units at least includes a first module unit and a second module unit. The host unit and the plurality of module units are connected with each other in a series connection relationship according to the inter-integrated circuit specifications. The network transmission method includes following steps. In a step (a), the host unit sending at least one request command packet to the plurality of module units, wherein the at least one request command packet includes a request command packet for virtual dynamic address configuration, a request command packet for total module unit number acquisition and a request command packet for at least one application operation. In a step (b), the plurality of module units generate at least one response command packet in response to the at least one request command packet. The step (a) includes sub-steps (a1), (a2) and (a3). In the sub-step (a1), the request command packet for virtual dynamic address configuration is sent to assign a virtual dynamic address uniquely corresponding to each of the host unit and the plurality of module units. In the sub-step (a2), the request command packet for total module unit number acquisition is sent to acquire a total number of the plurality of module units. In the sub-step (a3), the request command packet for the at least one application operation is sent according to the virtual dynamic address uniquely corresponding to each of the host unit and the plurality of module units and the total number of the plurality of module units. According to the request command packet for the at least one application operation, at least one specification parameter of each of the plurality of module units is acquired or set, or an operation status of each of the plurality of module units during operation is acquired or set.

In an embodiment, after the at least one request command packet is sent from the host unit, the at least one request command packet is transmitted downstream through the plurality of module units layer by layer in a serial communication manner, and the at least one request command packet is transmitted to a specified module unit of the plurality of module units corresponding to a preset virtual dynamic address in the at least one request command packet. In response to the at least one request command packet, the specified module unit sends the at least one response command packet, and the at least one response command packet is transmitted upstream to the host unit through the plurality of module units layer by layer in the serial communication manner.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the topology of a conventional inter-integrated circuit (I²C) bus;

FIG. 2 schematically illustrates the topology of a network architecture using an inter-integrated circuit (I²C) bus to integrate a host unit and a plurality of module units;

FIG. 3 schematically illustrates the constituents of the components in the network architecture shown in FIG. 2;

FIG. 4A schematically illustrates the format of the request command packet for the network architecture shown in FIG. 2;

FIG. 4B schematically illustrates the format of the response command packet for the network architecture shown in FIG. 2;

FIG. 5 is a timing diagram illustrating the state transitions during the process of establishing the corresponding virtual dynamic addresses of the host unit and the module units;

FIG. 6 is a timing diagram illustrating a method of determining the total number of module units in the network architecture of FIG. 2 according to the contents of the at least one request command packet and the at least one response command packet of FIGS. 4A and 4B;

FIG. 7 is a timing diagram illustrating a method of acquiring at least one specification parameter of any of the module units in the network architecture of FIG. 2 according to the contents of the at least one request command packet and the at least one response command packet of FIGS. 4A and 4B;

FIG. 8 is a timing diagram illustrating a method of setting an operation status of any of the module units in the network architecture of FIG. 2 according to the contents of the at least one request command packet and the at least one response command packet of FIGS. 4A and 4B; and

FIG. 9 is a flowchart of a network transmission method using I²C specifications according to an embodiment of the present invention.

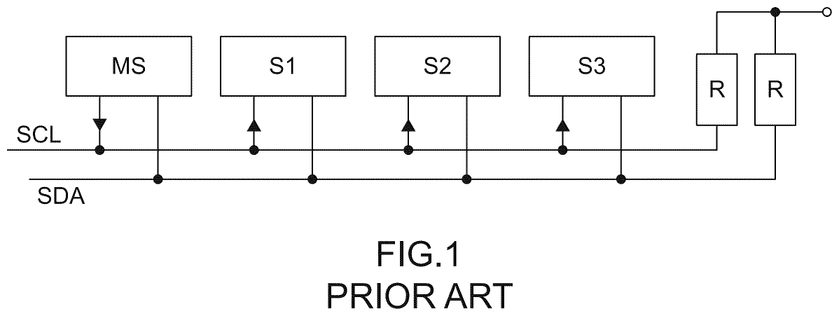

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. Furthermore, in order to clearly show the technical features of the present invention, unnecessary elements that can be completed by conventional techniques are not shown in the drawings of the embodiments.

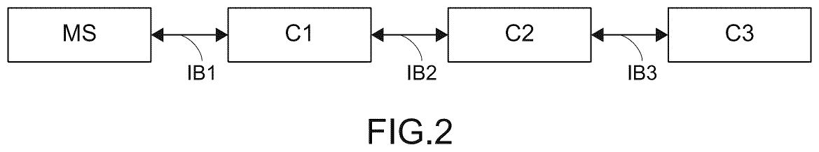

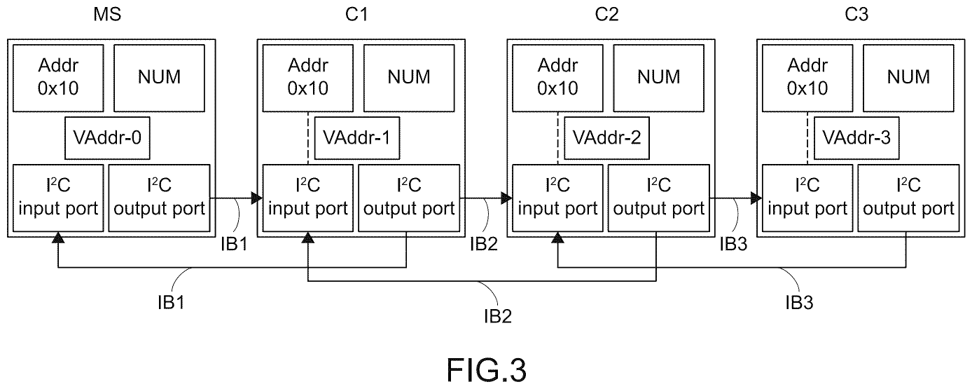

The present invention provides a network architecture. Hereinafter, the concepts of the network architecture will be illustrated with reference to FIG. 2 and FIG. 3. FIG. 2 schematically illustrates the topology of a network architecture using an inter-integrated circuit (I²C) bus to integrate a host unit and a plurality of module units. FIG. 3 schematically illustrates the constituents of the components in the network architecture shown in FIG. 2.

As shown in FIG. 2 and FIG. 3, a host unit MS and a plurality of module units (e.g., a first module unit C1, a second module unit C2 and a third module unit C3) are integrated into the network architecture through a plurality of inter-integrated circuit (I²C) buses IB1, IB2 and IB3. The number of the module units can be determined according to the practical requirements.

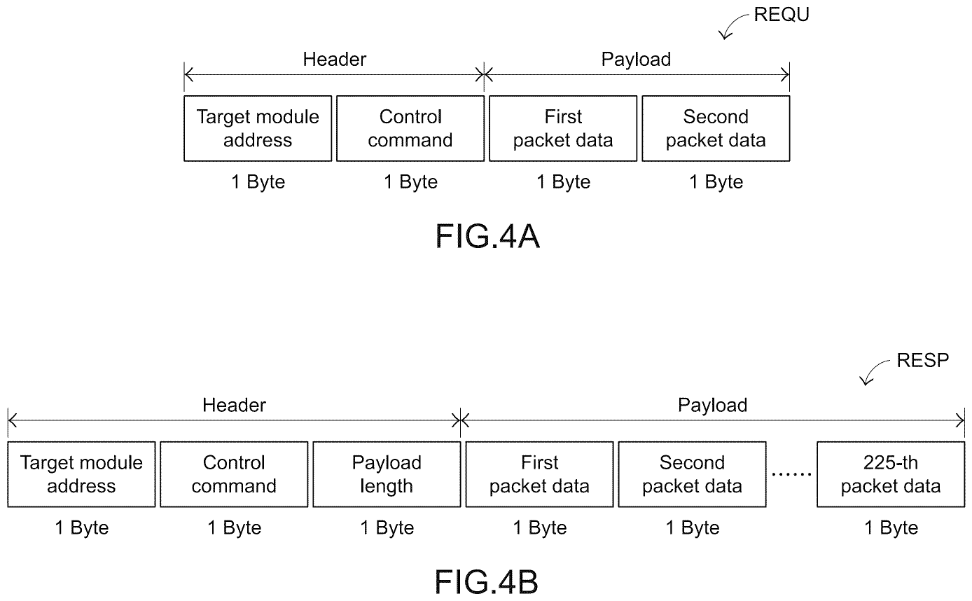

The host unit MS is used to generate at least one request command packet. The format of the request command packet will be described later in FIG. 4A. The module units C1, C2 and C3 are electrically connected with the host unit MS through the inter-integrated circuit (I²C) buses IB1, IB2 and IB3. The module units C1, C2 and C3 generate at least one response command packet. The format of the response command packet will be described later in FIG. 4B.

In accordance with a technical feature of the network architecture of the present invention, the first module unit C1 is electrically connected with the host unit MS, the second module unit C2 is electrically connected with the first module unit C1, and the third module unit C3 is electrically connected with the second module unit C2. Consequently, the host unit MS and the module units C1~C3 are connected in series in pairs to form a series connection relationship.

The logic relationship of the overall network packet flow will be described as follows. The host unit MS is located at the most upstream side (or the leftmost side) of the overall network packet flow, the third module unit C3 is located at the most downstream side (or the rightmost side) of the overall network packet flow. When the host unit MS transmits the at least one request command packet to the first module unit C1 through the bus IB1, the host unit MS plays a host role, and the first module unit C1 plays a slave role. Subsequently, when the first module unit C1 continuously transmits the at least one request command packet to the second module unit C2 through the bus IB2, the first module unit C1 plays the host role, and the second module unit C2 plays the slave role. Subsequently, when the second module unit C2 transmits the at least one request command packet to the third module unit C3 through the bus IB3, the second module unit C2 plays the host role, and the third module unit C3 plays the slave role.

The buses IB1, IB2 and IB3 also provide a function of sending the at least one response command packet from the module units C1~C3 back to the host unit MS, which will not be described in detail here.

In FIG. 2 and FIG. 3, the host unit MS and the third module unit C3 are located at the end positions. Consequently, the host unit MS is electrically connected with the single inter-integrated circuit (I²C) bus IB1, and the third module unit C3 is electrically connected with the single inter-integrated circuit (I²C) bus IB3. The first module unit C1 located at the middle node is electrically connected with two inter-integrated circuit (I²C) buses IB1 and IB2. Similarly, the second module unit C2 located at another middle node is electrically connected with two inter-integrated circuit (I²C) buses IB2 and IB3.

As mentioned above, in the network architecture of the present invention, the device that is only electrically connected with a single inter-integrated circuit (I²C) bus is certainly located at the end position.

An implementation example of the network architecture will be illustrated in more detail with reference to FIG. 2 and FIG. 3. Each of the host unit MS and the module units C1~C3 has an I²C input port and an I²C output port to achieve serial transmission between each other.

Furthermore, each of the host unit MS and the module units C1~C3 is preconfigured with a default device address (Addr) at the factory. For example, the default device address (Addr) of each of the host unit MS and the module units C1~C3 is 0x10. However, if the network architecture is installed and configured in the above manner, the result will inevitably be that the entire network becomes inoperative due to duplicate or conflicting device addresses.

In accordance with another technical feature of the network architecture of the present invention, the host unit MS actively assigns and stores a unique corresponding virtual dynamic address for each of the module units C1~C3 through a software setting method while utilizing the data storage space in each of the host unit MS and the module units C1~C3. For example, the host unit MS can assign a unique virtual dynamic address VAddr-0 for its own. Furthermore, the host unit MS actively assigns a unique virtual dynamic address VAddr-1 for the first module unit C1, the host unit MS actively assigns a unique virtual dynamic address VAddr-2 for the second module unit C2, and the host unit MS actively assigns a unique virtual dynamic address VAddr-1 for the third module unit C3.

As mentioned above, each of the host unit MS and the module units C1~C3 is assigned with the corresponding unique virtual dynamic address. After the at least one request command packet is sent from the host unit MS, the at least one request command packet is transmitted downstream through the module units C1~C3 layer by layer in the serial communication manner. According to a preset virtual dynamic address in the at least one request command packet, the at least one request command packet is transmitted to the module unit corresponding to the preset virtual dynamic address. In response to the at least one request command packet, the module unit corresponding to the preset virtual dynamic address issues the at least one response command packet. The at least one response command packet is transmitted upstream to the host unit MS through the module units C1~C3 layer by layer in the serial communication manner. Through the above implementation process, it is evident that the technologies of the present invention can effectively prevent the serious issue of address duplication or conflict encountered in conventional technologies.

Before the network architecture shown in FIGS. 2 and 3 performs any application operation, the host unit MS has to determine how many module units are currently connected to the network architecture. For achieving this purpose, the host unit MS stores the total number information NUM about the module units C1~C3 (e.g., 3 module units) in the data storage space in each of the host unit MS and the module units C1~C3 through a software setting method. Then, the stored total number information NUM can be used by each of the host unit MS and the module units C1~C3.

FIG. 4A schematically illustrates the format of the request command packet for the network architecture shown in FIG. 2. FIG. 4B schematically illustrates the format of the response command packet for the network architecture shown in FIG. 2.

As shown in FIG. 4A, the request command packet contains a header and a payload. The header at least contains a target module address and a control command, and the payload contains two sets of packet data.

In an embodiment, the data length of each of the target module address, the control command, the first packet data and the second packet data is one byte.

As shown in FIG. 4B, the response command packet RESP also contains a header and a payload. The header contains at least a target module address, a control command, and the length of the payload. The payload contains at least one packet data. For example, the payload contains at least one packet data and at most 255 packet data.

In an embodiment, the data length of each of the target module address and the control command is one byte, and the data length of each packet data is one byte.

Furthermore, the contents of the at least one request command packet REQU and the at least one response command packet RESP can be adjusted according to the practical requirements. That is, the contents of the at least one request command packet REQU and the at least one response command packet RESP are not restricted.

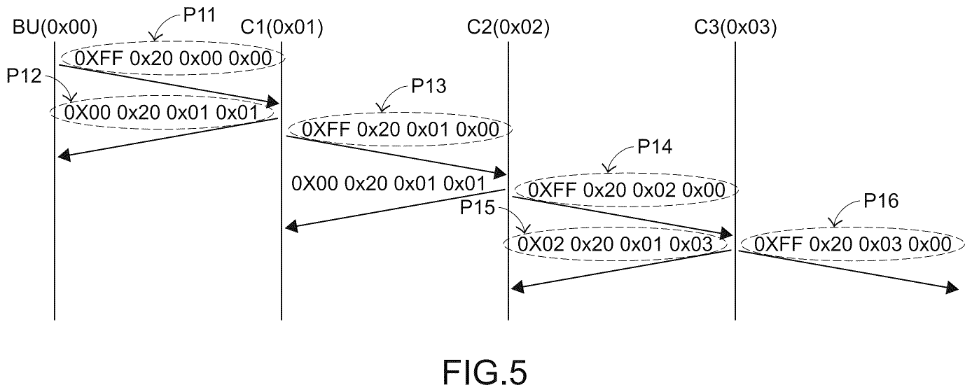

FIG. 5 is a timing diagram illustrating the state transitions during the process of establishing the corresponding virtual dynamic addresses (VAddr-0, VAddr-1, VAddr-2, VAddr-3) of the host unit (MS) and the module units C1~C3. In this drawing, the implementation concept of FIG. 2 and the at least one request command packet (REQU) and the at least one response command packet (RESP) in FIGS. 4A and 4B are shown.

When the request command packet REQU is used for virtual dynamic address assignment, this packet needs to be delivered to each of the module units C1~C3. Consequently, the target module address is set to 0xFF, indicating that the packet is a broadcasting packet rather than being directed to a specified module unit. Under this circumstance, the command code used for the control command that performs the virtual dynamic address assignment is 0x20. Accordingly, the request command packet for the virtual dynamic address assignment has the following content structure:

Header:

| Byte sequence | Byte content | Description |
|---|---|---|
| 0 | 0xFF | (sending) target module address |
| | | (broadcasting) address |
| 1 | 0x20 | Control command |

Payload:

| Byte sequence | Byte content | Description |
|---|---|---|
| 0 | 0x00 | sender virtual dynamic address |
| 1 | 0x00 | Control command |

After the request command packet REQU for virtual dynamic address assignment is received by any of the module units C1~C3, the corresponding response command packet is received. The response command packet has the following content structure:

Header:

| Byte sequence | Byte content | Description |
|---|---|---|
| 0 | 0xFF | (receiving) target module address |
| 1 | 0x20 | control command |
| 2 | 0x20 | length of payload |

Payload:

| Byte sequence | Byte content | Description |
|---|---|---|
| 0 | 0x01 | responder virtual dynamic address |

Please refer to FIG. 5. The format of the packet will be described in more detail as follows. For example, when the host unit MS sends a request command packet P11 for virtual dynamic address assignment, the content of the packet is 0xFF 0x20 0x00 0x00. In this packet, the underlined 0x00 indicates that the host unit MS first sets its own virtual dynamic address (VAddr-0) to 0x00 and also identifies itself as the sender. Subsequently, when the first module unit C1 receives the request packet P11, it sends a response command packet P12 (0x00 0x20 0x010x01) back to the host unit MS.

In the response command packet P12, the underlined 0x00 indicates that the packet is intended to be sent to the host unit MS, whose virtual dynamic address VAddr-0 is 0x00. The earlier underlined 0x01 in the response command packet P12 indicates that the length of the payload is 1 byte. The later underlined 0x01 in the response command packet P12 indicates that the virtual dynamic address VAddr-1 will be automatically incremented by 1 and set to 0x01 when the virtual dynamic address VAddr-0 (0x00) of the host unit MS is seen by the first module unit C1. Consequently, as the sender of the above response command packet P12 (0x00 0x20 0x01 0x01), the first module unit C1 has a virtual dynamic address VAddr-1 of 0x01.

Similarly, before the first module unit C1 sends the above request command packet P11 (0xFF 0x20 0x00 0x00) to the second module unit C2, the first module unit C1 needs to update a part of the content in the request command packet P11 to form a new request command packet P13: 0xFF 0x20 0x01 0x00.

When the third module unit C3 receives the request command packet P14 (0xFF 0x20 0x02 0x00) from the second module unit C2 (whose virtual dynamic address VAddr-2 is 0x02), it sends a response command packet P15 (0x02 0x20 0x01 0x03) back to the second module unit C2. In the response command packet P15, the underlined 0x02 indicates that the response command packet P15 is intended to be sent to the second module unit C2, the underlined 0x01 denotes the length of the response payload (1 byte), and the underlined 0x03 denotes the virtual dynamic address of the responder (i.e., the third module unit C3)

Similarly, before the third module unit C3 sends the above request command packet P14 (0xFF 0x20 0x02 0x00) to the next module unit, the third module unit C3 needs to update a part of the content in the request command packet P14 to form a new request command packet P15: 0xFF 0x20 0x03 0x00. However, the third module unit C3 is not electrically connected to any other module units downstream. Consequently, if the third module unit C3 has not received any response command packet after a certain period of time, it means that the third module unit C3 is an end-position module unit.

Through the operations illustrated in FIG. 5, the host unit (MS) and the module units C1~C3 are assigned with respective unique virtual dynamic address: VAddr-0 (i.e., 0x00), VAddr-1 (i.e., 0x01), VAddr-2 (i.e., 0x02), and VAddr-3 (i.e., 0x03). Consequently, before performing at least one application operation using the network architecture shown in FIGS. 2 and 3, the problems of duplicate or conflicting device addresses will be avoided.

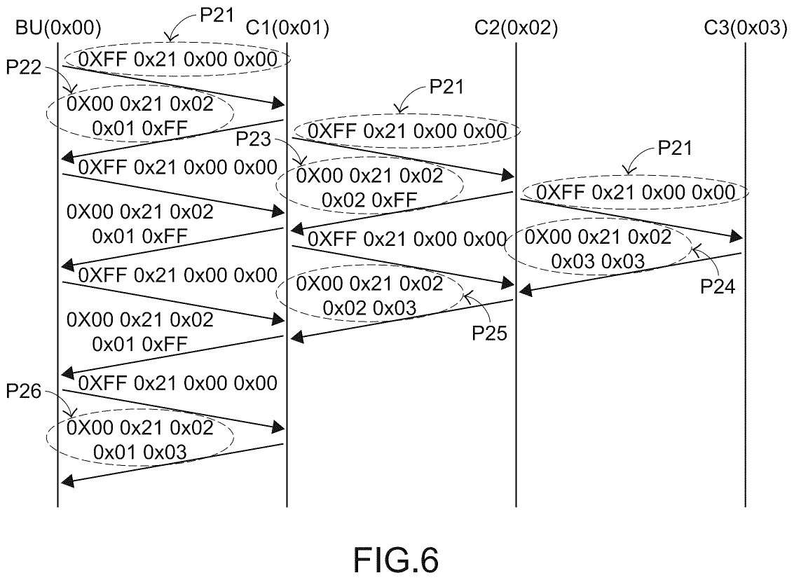

A method of determining how many module units are simultaneously connected to the same network architecture can be illustrated with reference to FIG. 6. FIG. 6 is a timing diagram illustrating a method of determining the total number of module units in the network architecture of FIG. 2 according to the contents of the at least one request command packet REQU and the at least one response command packet RESP of FIGS. 4A and 4B.

In case that the request command packet REQU is a request for obtaining the total number of module units, the request command packet REQU needs to be transmitted to any of the module units C1~C3. Therefore, the target module address is set to 0xFF, indicating that the packet is a broadcasting packet and is not limited to being sent to a specified module unit. Under this circumstance, the command code of the control command used to obtain the total number of module units is set to 0x21. Accordingly, the request command packet for obtaining the total number of module units has the following content structure:

Header:

| Byte sequence | Byte content | Description |
|---|---|---|
| 0 | 0xFF | (sending) target module address |
| | | (broadcasting) address |
| 1 | 0x21 | Control command |

Payload:

| Byte sequence | Byte content | Description |
|---|---|---|
| 0 | 0x00 | padding |
| 1 | 0x00 | padding |

After the request command packet REQU for obtaining the total number of module units is received by any of the module units C1~C3, the corresponding response command packet is received. The response command packet has the following content structure:

Header:

| Byte sequence | Byte content | Description |
|---|---|---|
| 0 | 0x00 | (receiving) target module address |
| 1 | 0x21 | control command |
| 2 | 0x02 | length of payload |

Payload:

| Byte | Byte | |
|---|---|---|
| sequence | content | Description |
| 0 | 0x01 | responder virtual dynamic address |
| 0 | 0xFF | 0xFF: number of module unit is unknown |
| | | 0x03: number of connected module units is 3 |

Please refer to FIG. 6. The format of the packet will be described in more detail as follows. For example, when a request command packet P21 for obtaining the total number of module units is sent from the host unit MS to the first module unit C1, the first module unit C1 sends a response command packet P22 (0x00 0x21 0x02 0x01 0xFF) back to the host unit MS because the request command packet P21 has not reached the final endpoint (i.e., the third module unit C3). In the response command packet P22, the underlined 0x00 indicates that the packet is intended to be sent to the host unit MS, whose virtual dynamic address VAddr-0 is 0x00. The underlined 0x21 in the response command packet P22 denotes the command code of the control command used to obtain the total number of module units.

In the response command packet P22, the underlined 0x02 indicates that the length of the response payload is 2 bytes, the underlined 0x01 represents the virtual dynamic address of the responder (i.e., the first module unit C1), i.e., VAddr-1 is 0x01. In addition, the underlined 0xFF indicates that the number of module units is currently unknown.

Subsequently, the request command packet P21 for obtaining the total number of module units is sent from the first module unit C1 to the second module unit C2. Meanwhile, the request command packet P21 has not reached the final endpoint (i.e., the third module unit C3). When the request command packet P21 is sent to the second module unit C2, the second module unit C2 sends a response command packet P23 (0x00 0x21 0x02 0x02 0xFF) back to the first module unit C1. The content of the response command packet P23 is substantially identical to that of the response command packet P22 except that the underlined 0x02 represents the virtual dynamic address of the responder (i.e., the second module unit C2), i.e., VAddr-2 is 0x02. The rest may be deduced by analogy.

The above procedures are repeatedly done. When the request command packet P21 for obtaining the total number of module units is sent from the second module unit C2 to the third module unit C3, the request command packet P21 has reached the final endpoint (i.e., the third module unit C3). Meanwhile, the total number information NUM about the module units C1~C3 is known. That is, the total number information NUM is 3, representing three module units.

When the request command packet P21 is sent to the third module unit C3, the third module unit C3 sends a response command packet P24 (0x00 0x21 0x02 0x03 0x03) back to the second module unit C2. In the response command packet P24, the former underlined \vec{0x03} represents the virtual dynamic address of the responder (i.e., the third module unit C3), and the later underlined \vec{0x03} indicates that the total number information NUM about the module units C1~C3 is 3 (i.e., three module units). The total number information NUM about the module units C1~C3 is stored in the third module unit C3.

Subsequently, the second module unit C2 sends a response command packet P25 (0x00 0x21 0x02 \vec{0x02} 0x03) to the first module unit C1. In the response command packet P25, the underlined \vec{0x02} represents the virtual dynamic address of the responder (i.e., the second module unit C2). The above responding procedures are repeatedly done until the first module unit C1 sends a response command packet P26 (0x00 0x21 0x02 \vec{0x01} 0x03) to the host unit MS. In the response command packet P26, the underlined 0x01 represents the virtual dynamic address of the responder (i.e., the first module unit C1).

After the above procedures are completed, the total number information NUM about the module units C1~C3 (e.g., 3 module units) is stored in the data storage space in each of the host unit MS and the module units C1~C3 shown in FIG. 3.

As mentioned above, the host unit MS and the module units C1~C3 shown in FIG. 3 have respective unique virtual dynamic addresses VAddr-0 (i.e., 0x00), VAddr-1 (i.e., 0x01), VAddr-2 (i.e., 0x02) and VAddr-3 (i.e., 0x03), and the total number information NUM about the module units C1~C3 (e.g., 3 module units) is stored in the data storage space in each of the host unit MS and the module units C1~C3. Subsequently, various application operations are performed. For example, the application operations are performed to acquire at least one specification parameter of any of the module units C1~C3 or acquire an operation status of each module unit during operation. The application operations will be illustrated as follows.

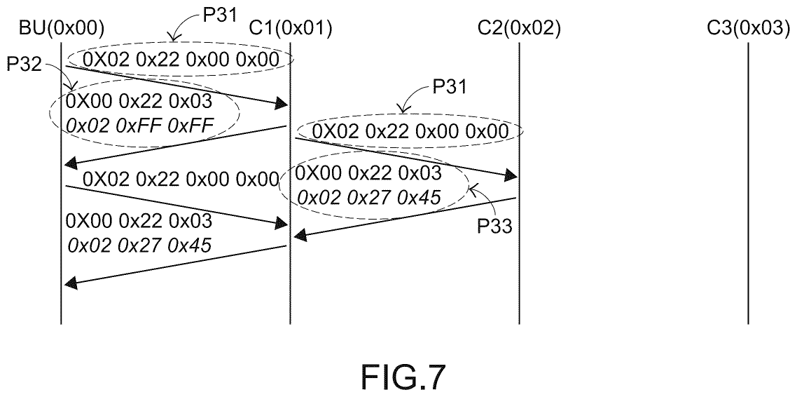

FIG. 7 is a timing diagram illustrating a method of acquiring at least one specification parameter of any of the module units C1~C3 in the network architecture of FIG. 2 according to the contents of the at least one request command packet REQU and the at least one response command packet RESP of FIGS. 4A and 4B. An example of the specification parameter is the negative temperature coefficient (NTC) value of the thermistor element in the module unit. It is noted that the example of the specification parameter is not restricted.

The request command packet for acquiring the negative temperature coefficient (NTC) value of the thermistor element in the module unit has the following content structure:

Header:

| Byte sequence | Byte content | Description |
|---|---|---|
| 0 | 0x02 | (sending) target module address |
| 1 | 0x02 | Control command |

Payload:

| Byte sequence | Byte content | Description |
|---|---|---|
| 0 | 0x00 | padding |
| 1 | 0x00 | padding |

After any of the module units C1~C3 receives the request command packet REQU for acquiring the negative temperature coefficient (NTC) value, the module unit sends a corresponding response command packet. The response command packet has the following content structure:

Header:

| Byte sequence | Byte content | Description |
|---|---|---|
| 0 | 0x00 | (receiving) target module address |
| 1 | 0x22 | control command |
| 2 | 0x03 | length of payload |

Payload:

| Byte | Byte | |
|---|---|---|
| sequence | content | Description |
| 0 | 0x02 | Virtual dynamic address of the module providing |
| | | the NTC value |
| 1 | 0x03 | High byte of the NTC value |
| 2 | 0xF1 | Low byte of the NTC value |

Please refer to FIG. 7. The format of the packet will be described in more detail as follows. For example, the request command packet REQU is a packet for acquiring the negative temperature coefficient (NTC) value of the thermistor element in the second module unit C2 shown in FIG. 2. For example, a request command packet P31 for acquiring the negative temperature coefficient (NTC) value is sent from the host unit MS to the second module unit C2, and the content of the request command packet P31 is 0x02 0x22 0x00 0x00. In the request command packet P31, the underlined 0x02 indicates that the packet is intended to be sent to the second module unit C2, whose virtual dynamic address VAddr-2 is 0x02. The underlined 0x22 in the request command packet P31 represents the command code of the control command used to acquire the negative temperature coefficient (NTC) value.

When the request command packet P31 is sent to the first module unit C1, the first module unit C1 sends a response command packet P32 (0x00 0x22 0x03 0x02 0xFF 0xFF) back to the host unit MS (whose virtual dynamic addresses VAddr-0 is 0x00) because the first module unit C1 is not the target module unit. In the response command packet P32, the underlined 0x02 indicates that the negative temperature coefficient (NTC) value of the second module unit C2 is intended to be acquired. The underlined 0xFF 0xFF in the response command packet P32 indicates that the first module unit C1 currently does not know the negative temperature coefficient (NTC) value of the second module unit C2. Consequently, it can only send 0xFF 0xFF to represent unknown data.

When the request command packet P31 is successively transmitted from the first module unit C1 to the second module unit C2, the second module unit C2 sends a response command packet P33 (0x00 0x22 0x03 0x02 0x27 0x45) back to the first module unit C1 because the second module unit C2 is the target module unit. In the response command packet P33, the underlined 0x00 indicates that the acquired negative temperature coefficient (NTC) value is intended to be sent to the host unit MS (whose virtual dynamic addresses VAddr-0 is 0x00). The underlined 0x02 0x27 0x45 in the response command packet P33 represents the negative temperature coefficient (NTC) value of the second module unit C2.

Consequently, the host unit MS is able to successfully retrieve the negative temperature coefficient (NTC) value of the second module unit C2, which is 2745.

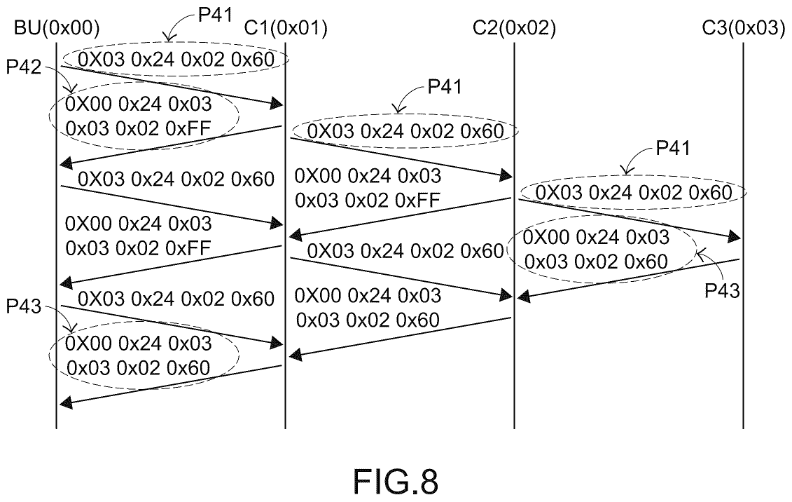

FIG. 8 is a timing diagram illustrating a method of setting an operation status of any of the module units C1~C3 in the network architecture of FIG. 2 according to the contents of the at least one request command packet REQU and the at least one response command packet RESP of FIGS. 4A and 4B. An example of the operation status is an operation parameter of a fan in the module unit. It is noted that the example of the operation status is not restricted.

The request command packet for setting the operation parameter of the fan in the module unit has the following content structure:

Header:

| Byte sequence | Byte content | Description |
|---|---|---|
| 0 | 0x03 | (sending) target module address |
| 1 | 0x24 | Control command |

Payload:

| Byte sequence | Byte content | Description |
|---|---|---|
| 0 | 0x02 | A total of seven rotation speed modes: |
| | | 0x00, 0x01, . . . , 0x06 |
| 1 | 0x05 | rotation speed: 0~100 |

After any of the module units C1~C3 receives the request command packet for setting the operation parameter of the fan in the module unit, the module unit sends a corresponding response command packet. The response command packet has the following content structure:

Header:

| Byte sequence | Byte content | Description |
|---|---|---|
| 0 | 0x00 | (receiving) target module address |
| 1 | 0x24 | control command |
| 2 | 0x03 | length of payload |

Payload:

| Byte | Byte | |
|---|---|---|
| sequence | content | Description |
| 0 | 0x03 | Virtual dynamic address of the module whose fan |
| | | operation parameter is intended to be set |
| 1 | 0x02 | A total of seven rotation speed modes: 0x00, |
| | | 0x01, . . . , 0x06 |
| 2 | 0x05 | rotation speed: 0~100 |

Please refer to FIG. 8. The format of the packet will be described in more detail as follows. For example, the request command packet REQU is a packet for setting the fan operation parameter of the third module unit C3 shown in FIG. 2. For example, a request command packet P41 for setting the fan operation parameter is sent from the host unit MS to the third module unit C3, and the content of the request command packet P41 is 0x03 0x24 0x02 0x60. In the request command packet P41, the underlined 0x03 indicates that the packet is intended to be sent to the third module unit C3, whose virtual dynamic address VAddr-3 is 0x03. The underlined 0x24 in the request command packet P41 represents the command code of the control command used to set the fan operation parameter.

The underlined 0x02 0x60 in the request command packet P41 represents the value that is sent from the host unit MS for setting the fan operation parameter.

When the request command packet 431 is sent to the first module unit C1, the first module unit C1 sends a response command packet P42 (0x00 0x24 0x03 0x03 0x02 0xFF) back to the host unit MS (whose virtual dynamic addresses VAddr-0 is 0x00) because the first module unit C1 is not the target module unit. In the response command packet P42, the underlined 0x03 indicates that the third module unit C3 is the target module unit and its fan operation parameter is intended to be set. The underlined 0x02 0xFF in the response command packet P42 indicates that the first module unit C1 has known the fan operation parameter related to the third module unit C3, in which the rotation speed mode is intended to be set to 0x02. However, since the request command packet P41 has not been sent to the third module unit C3, the underlined 0xFF is subsequently used to indicate that the setting of third module unit C3 has not yet been completed.

When the request command packet P41 is successively transmitted from the first module unit C1 to the third module unit C3 through the second module unit C2, the third module unit C3 sends a response command packet P43 (0x00 0x24 0x03 0x03 0x02 0x60) back to the second module unit C2 because the third module unit C3 is the target module unit. In the response command packet P43, the underlined 0x00 indicates that the acquired information is intended to be sent to the host unit MS (whose virtual dynamic addresses VAddr-0 is 0x00). The underlined 0x03 0x02 0x60 in the response command packet P43 indicates that the fan operation parameter in the third module unit C3 has been set. Consequently, the host unit MS is able to successfully complete the process and confirm that the fan operation parameter of the third module unit C3 have been configured to the value: 0x02 0x60.

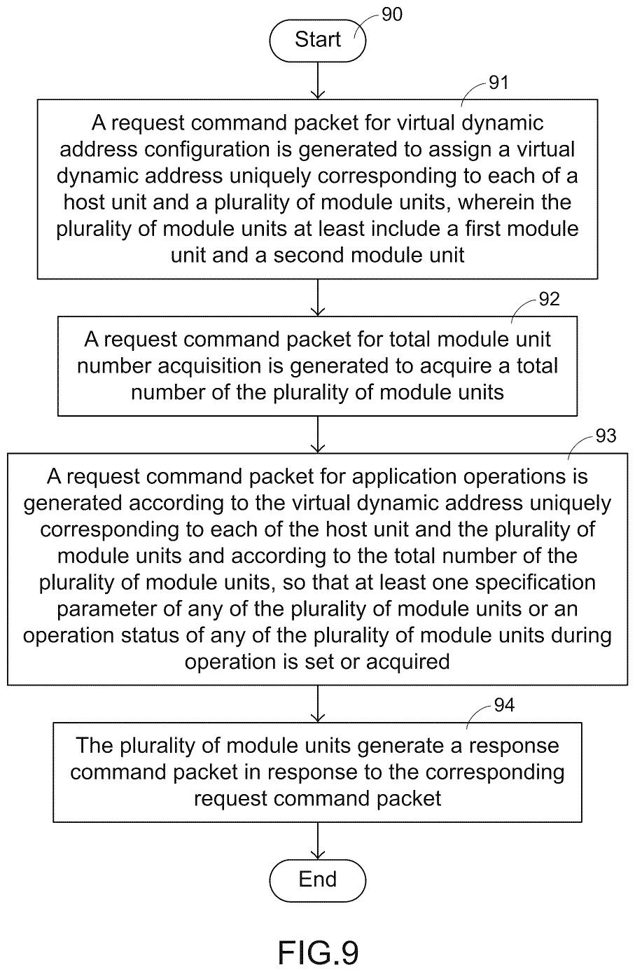

The present invention further provides a network transmission method using inter-integrated circuit (I²C) specifications. FIG. 9 is a flowchart of a network transmission method using I²C specifications according to an embodiment of the present invention.

In a step 90, the flowchart of the network transmission method starts.

In a step S91, a request command packet for virtual dynamic address configuration is generated to assign a virtual dynamic address uniquely corresponding to each of a host unit and a plurality of module units, wherein the plurality of module units at least include a first module unit and a second module unit.

In a step S92, a request command packet for total module unit number acquisition is generated to acquire a total number of the plurality of module units.

In a step S93, a request command packet for application operations is generated according to the virtual dynamic address uniquely corresponding to each of the host unit and the plurality of module units and according to the total number of the plurality of module units, so that at least one specification parameter of any of the plurality of module units or an operation status of any of the plurality of module units during operation is set or acquired.

In a step S94, the plurality of module units generate a response command packet in response to the corresponding request command packet.

From the above descriptions, the present invention provides a network architecture and a network transmission method using inter-integrated circuit specifications. Consequently, the problems of duplicate or conflicting device addresses will be avoided. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A network architecture using inter-integrated circuit specifications, the network architecture comprising:
a host unit generating at least one request command packet; and
a plurality of module units, wherein the plurality of module units at least comprise a first module unit and a second module unit, which are electrically connected with the host unit according to the inter-integrated circuit specifications, wherein the plurality of module units generate at least one response command packet in response to the at least one request command packet,
wherein the first module unit is electrically connected with the host unit, and the second module unit is electrically connected with the first module unit, so that the host unit, the first module unit and the second module unit are connected with each other in a series connection relationship,
wherein according to a network communication protocol comprising the at least one request command packet and the at least one response command packet, the host unit assigns a virtual dynamic address uniquely corresponding to each of the host unit and the plurality of module units and acquires a total number of the plurality of module units, so that at least one application operation is performed.

2. The network architecture according to claim 1, wherein each of the at least one request command packet contains a header and a payload.

3. The network architecture according to claim 2, wherein the header at least contains a target module address and a control command, and the payload contains a first packet data and a second packet data, wherein a data length of each of the target module address, the control command, the first packet data and the second packet data is one byte.

4. The network architecture according to claim 1, wherein each of the at least one response command packet contains a header and a payload.

5. The network architecture according to claim 4, wherein the header contains at least a target module address, a control command and a payload length, and the payload contains at least one packet data, wherein a data length of each of the target module address, the control command, the payload length and the at least one packet data is one byte.

6. The network architecture according to claim 1, wherein the at least one request command packet comprises a request command packet for virtual dynamic address configuration, a request command packet for total module unit number acquisition and a request command packet for the at least one application operation.

7. The network architecture according to claim 6, wherein according to the request command packet for virtual dynamic address configuration, the virtual dynamic address uniquely corresponding to each of the host unit and the plurality of module units is assigned.

8. The network architecture according to claim 6, wherein according to the request command packet for total module unit number acquisition, the total number of the plurality of module units is acquired.

9. The network architecture according to claim 6, wherein according to the request command packet for the at least one application operation, at least one specification parameter of each of the plurality of module units is acquired or set, or an operation status of each of the plurality of module units during operation is acquired or set.

10. The network architecture according to claim 1, wherein after the at least one request command packet is sent from the host unit, the at least one request command packet is transmitted downstream through the plurality of module units layer by layer in a serial communication manner, and the at least one request command packet is transmitted to a specified module unit of the plurality of module units corresponding to a preset virtual dynamic address in the at least one request command packet, wherein in response to the at least one request command packet, the specified module unit sends the at least one response command packet, and the at least one response command packet is transmitted upstream to the host unit through the plurality of module units layer by layer in the serial communication manner.

11. A network architecture using inter-integrated circuit specifications, the network architecture comprising:
a host unit generating at least one request command packet; and
a plurality of module units, wherein the plurality of module units at least comprise a first module unit and a second module unit, which are electrically connected with the host unit according to the inter-integrated circuit specifications, wherein the plurality of module units generate at least one response command packet in response to the at least one request command packet,
wherein the first module unit is electrically connected with the host unit, and the second module unit is electrically connected with the first module unit, so that the host unit, the first module unit and the second module unit are connected with each other in a series connection relationship,
wherein after the at least one request command packet is sent from the host unit, the at least one request command packet is transmitted downstream through the plurality of module units layer by layer in a serial communication manner, and the at least one request command packet is transmitted to a specified module unit of the plurality of module units corresponding to a preset virtual dynamic address in the at least one request command packet, wherein in response to the at least one request command packet, the specified module unit sends the at least one response command packet, and the at least one response command packet is transmitted upstream to the host unit through the plurality of module units layer by layer in the serial communication manner.

12. The network architecture according to claim 11, wherein each of the at least one request command packet contains a header and a payload.

13. The network architecture according to claim 12, wherein the header at least contains a target module address and a control command, and the payload contains a first packet data and a second packet data, wherein a data length of each of the target module address, the control command, the first packet data and the second packet data is one byte.

14. The network architecture according to claim 11, wherein each of the at least one response command packet contains a header and a payload.

15. The network architecture according to claim 14, wherein the header contains at least a target module address, a control command and a payload length, and the payload contains at least one packet data, wherein a data length of each of the target module address, the control command, the payload length and the at least one packet data is one byte.

16. The network architecture according to claim 11, wherein according to a network communication protocol comprising the at least one request command packet and the at least one response command packet, the host unit assigns a virtual dynamic address uniquely corresponding to each of the host unit and the plurality of module units and acquires a total number of the plurality of module units, so that at least one application operation is performed.

17. The network architecture according to claim 16, wherein the at least one request command packet comprises a request command packet for virtual dynamic address configuration, a request command packet for total module unit number acquisition and a request command packet for the at least one application operation.

18. The network architecture according to claim 17, wherein according to the request command packet for virtual dynamic address configuration, the virtual dynamic address uniquely corresponding to each of the host unit and the plurality of module units is assigned, wherein according to the request command packet for total module unit number acquisition, the total number of the plurality of module units is acquired, wherein according to the request command packet for the at least one application operation, at least one specification parameter of each of the plurality of module units is acquired or set, or an operation status of each of the plurality of module units during operation is acquired or set.

19. A network transmission method for a network architecture using inter-integrated circuit specifications, the network architecture comprising a host unit and a plurality of module units, the plurality of module units at least comprising a first module unit and a second module unit, the host unit and the plurality of module units being connected with each other in a series connection relationship according to the inter-integrated circuit specifications, the network transmission method comprising steps of:
(a) the host unit sending at least one request command packet to the plurality of module units, wherein the at least one request command packet comprises a request command packet for virtual dynamic address configuration, a request command packet for total module unit number acquisition and a request command packet for at least one application operation; and
(b) the plurality of module units generating at least one response command packet in response to the at least one request command packet,
wherein the step (a) comprises sub-steps of:
(a1) sending the request command packet for virtual dynamic address configuration to assign a virtual dynamic address uniquely corresponding to each of the host unit and the plurality of module units;
(a2) sending the request command packet for total module unit number acquisition to acquire a total number of the plurality of module units; and
(a3) sending the request command packet for the at least one application operation according to the virtual dynamic address uniquely corresponding to each of the host unit and the plurality of module units and the total number of the plurality of module units, wherein according to the request command packet for the at least one application operation, at least one specification parameter of each of the plurality of module units is acquired or set, or an operation status of each of the plurality of module units during operation is acquired or set.

20. The network transmission method according to claim 19, wherein after the at least one request command packet is sent from the host unit, the at least one request command packet is transmitted downstream through the plurality of module units layer by layer in a serial communication manner, and the at least one request command packet is transmitted to a specified module unit of the plurality of module units corresponding to a preset virtual dynamic address in the at least one request command packet, wherein in response to the at least one request command packet, the specified module unit sends the at least one response command packet, and the at least one response command packet is transmitted upstream to the host unit through the plurality of module units layer by layer in the serial communication manner.
